(19) United States
(12) Patent Application Publication
(10) Pub. No.: US 2015/0258556 A1
(43) Pub. Date: Sep. 17, 2015

(54) RECLAMATION SYSTEM FOR A CONTROLLED DROPLET APPLICATOR

(71) Applicants: Justin BAK, Windom,, MN (US); AGCO CORPORATION, Duluth,, GA (US)

(72) Inventor: Justin Bak, Windom, MN (US)

(73) Assignee: AGCO Corporation, Duluth,, GA (US)

(21) Appl. No.: 14/432,293

(22) PCT Filed: Sep. 27, 2013
(86) PCT No.: PCT/US13/62077

§ 371 Date: Mar. 30, 2015

Related U.S. Application Data
(60) Provisional application No. 61/707,637, filed on Sep. 28, 2012.

(51) Int. Cl. B05B 3/10

(52) U.S. Cl. CPC B05B 3/1021; B05B 3/1014

(57) ABSTRACT

A controlled droplet applicator (CDA) reclamation method includes deflecting a portion of fluid dispersed from a rotating cup of a CDA nozzle, the deflection causing a change from a circular spray pattern to a truncated spray pattern. The deflected fluid portion is collected in a reclamation shroud encircling a lip of the cup.

### CROSS REFERENCE TO RELATED APPLICATION

This application claims the benefit of U.S. Provisional Application No. 61/707,637, filed Sep. 28, 2012, which is hereby incorporated by reference in its entirety.

### TECHNICAL FIELD

The present disclosure is generally related to spraying technology, and, more particularly, to controlled droplet applications.

### BACKGROUND

A controlled droplet applicator (CDA) nozzle operates on a completely different principle than conventional hydraulic nozzles. CDA nozzles deposit liquid fluid to be applied on the inside of a spinning cup or cone. The inside of the cup may be lined with ridges traveling from the narrow end of the cup to the wide end. These ridges help impart rotational energy to the fluid spinning it faster. The ends of the ridges are used to shear the flowing liquid fluid into droplets. As the CDA cone spins faster, the smaller droplets get sheared and released from the end of the ridges, which enables the spectrum of droplet sizes to be controlled by adjusting the speed of the CDA cup.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1A is a schematic diagram generally depicting an embodiment of an example controlled droplet applicator (CDA) system with a CDA nozzle in horizontal orientation and covered in part by a reclamation shroud.

FIG. 1B is a schematic diagram showing select features in cut-away view of the example CDA system shown in FIG. 1A.

FIG. 1C is a schematic diagram showing certain features in exploded view of the example CDA system shown in FIG. 1A.

FIG. 1D is a schematic diagram of an embodiment of an example CDA nozzle cup in a perspective view showing a portion of an interior of the CDA nozzle cup.

FIG. 2 is a schematic diagram that illustrates, in a top plan view, an example, directional spray pattern provided by an example CDA system and a reclamation system.

FIG. 3 is a schematic diagram of an embodiment of an example CDA nozzle having a reclamation shroud that recovers fluid blocked by a deflector of the CDA nozzle.

FIG. 4 is a schematic diagram of an embodiment of an example reclamation shroud that cooperates with a deflector to recover dispersed fluid blocked by the deflector.

FIG. 5 is a flow diagram of an embodiment of an example CDA reclamation method.

### DESCRIPTION OF EXAMPLE EMBODIMENTS

### Overview

In one embodiment, a controlled droplet applicator (CDA) reclamation method comprising deflecting a portion of fluid dispersed from a rotating cup of a CDA nozzle, the deflection causing a change from a circular spray pattern to a truncated spray pattern; and collecting the deflected fluid portion in a reclamation shroud encircling a lip of the cup.

### DETAILED DESCRIPTION

Certain embodiments of a controlled droplet applicator (CDA) system and associated reclamation method are disclosed that collects liquid fluid that is deflected from the dispersed output of a CDA nozzle, controlling liquid fluid release and conserving the sprayed liquid (e.g., to avoid being applied to unwanted targets). For instance, the uniform droplets of fluid are dispersed in a circular pattern from a lip of a cup or cone. The reclamation shroud is coupled to (e.g., mounted to or integrated with, such as via a molded or cast assembly) a deflector that covers a portion of the lip. The deflector blocks the circular spray, resulting in a truncated spray that passes an aperture in the deflector and is applied to a target, such as crop or the ground. The reclamation shroud encircles the lip and hence collects the liquid fluid (hereinafter, liquid fluid merely referred to as fluid) blocked by the deflector. The reclamation shroud channels the collected fluid to a drain where the fluid is transferred (e.g., via a fluid transfer device, such as a pump or eductor) to a reservoir. The reservoir may be used as a source for feeding to the input of the nozzle, or in some embodiments, used for other purposes.

The deflector enables a CDA nozzle to control the direction of uniformly sized droplets that are characteristically produced by CDA-type nozzles. The CDA nozzle cup (and hence reclamation shroud) may be configured in the horizontal orientation (e.g., with the center axis of the cup coincident with the horizontal axis), or any other orientation, for precise and directional control of the direction of the applied fluid spray to the intended target.

Although conventional CDA system designs also produce droplets of uniform size with a lower fluid input than hydraulic nozzles, they comprise cups that are oriented in, and hence spun in, a vertical or near vertical orientation (e.g., within ten (10) degrees of the vertical axis) to provide a circular pattern. Since the fluid is not deflected, the need or motivation for a reclamation shroud has not been present.

Having summarized certain features of CDA systems of the present disclosure, reference will now be made in detail to the description of the disclosure as illustrated in the drawings. While the disclosure will be described in connection with these drawings, there is no intent to limit it to the embodiment or embodiments disclosed herein. For instance, in the description that follows, the focus is on a horizontal orientation of the CDA nozzle (including the cup), with the understanding that vertical or other orientations may be achieved in certain embodiments. Further, although the description identifies or describes specifics of one or more embodiments, such specifics are not necessarily part of every embodiment, nor are all various stated advantages necessarily associated with a single embodiment or all embodiments. On the contrary, the intent is to cover all alternatives, modifications and equivalents included within the spirit and scope of the disclosure as defined by the appended claims. Further, it should be appreciated in the context of the present disclosure that the claims are not necessarily limited to the particular embodiments set out in the description.

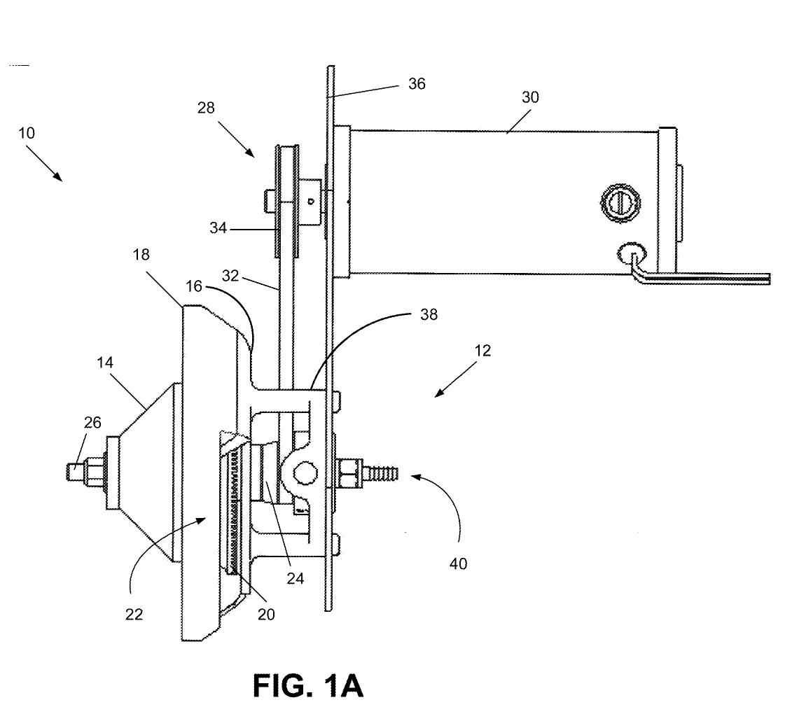

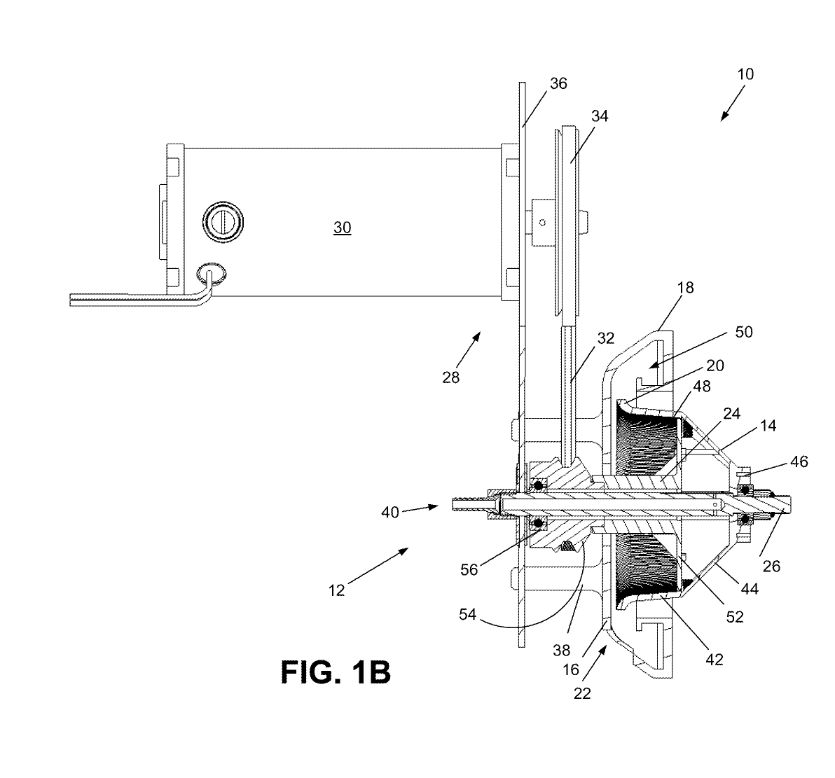

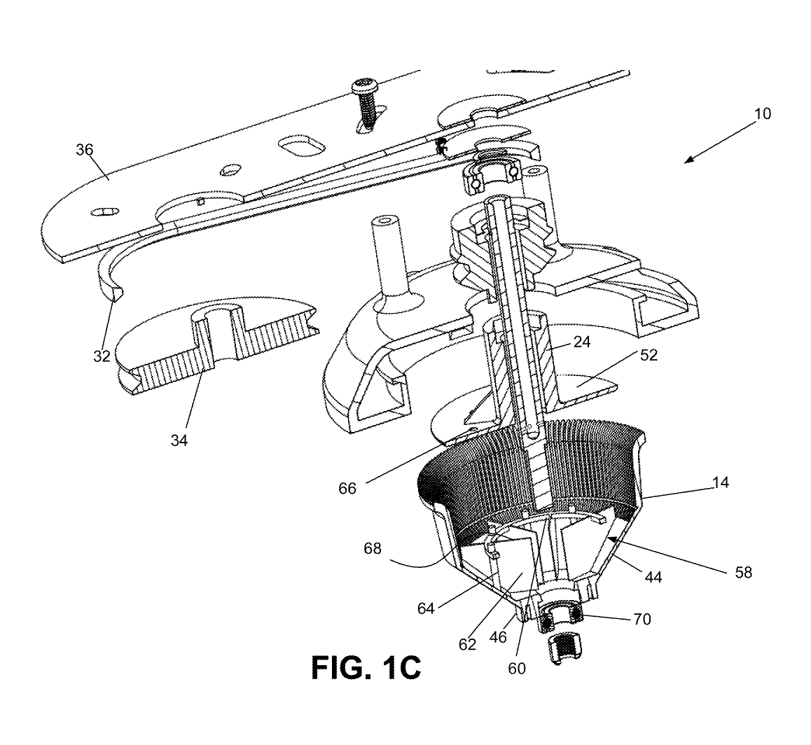

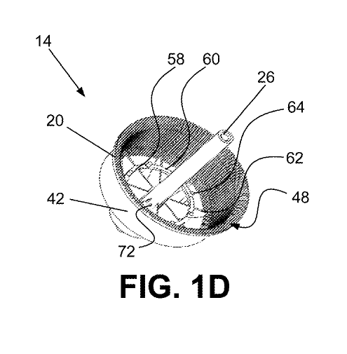

FIGS. 1A-1D depict several illustrations of an embodiment of a CDA system 10, with each illustration focusing on select features of the system. One having ordinary skill in the art should appreciate in the context of the present disclosure that the CDA system 10 shown in, and described in association with, FIGS. 1A-1D, is merely illustrative, and that other system arrangements with fewer or additional components are contemplated to be within the scope of the disclosure. As is evident by comparison among FIGS. 1A-1D, certain features are omitted in each figure to emphasize the features shown in a particular figure. Referring now to FIG. 1A, shown is an embodiment of an example CDA system 10 capable of reclaiming blocked fluid spray. The CDA system 10 may be used in an agricultural environment, such as to spray fluids (e.g., chemicals) on crops, bare ground, etc., as pre-emergence and/or post-emergence herbicides, fungicides, and insecticides. The CDA system 10 may be secured to a tractor frame, boom, among other agricultural equipment similar to implementations for conventional CDA nozzles. Further, a boom may have a plurality of CDA systems 10 arranged along the boom. In some embodiments, the CDA system 10 may be used in other environments, such as those requiring the application of other types of fluids to other surfaces. The CDA system 10 exhibits some of the well-known characteristics of conventional CDA nozzles, including the provision of a substantially uniform size fluid droplet based on low flow inputs.

The CDA system 10 comprises a CDA nozzle 12 that is depicted in FIG. 1A in the horizontal orientation, though any orientation may be used. The CDA nozzle 12 comprises a cup 14, a deflector 16, and a reclamation shroud 18 that is coupled to (e.g., molded or connected in some other fashion, such as via screws, adhesion, conforming fit, among other known fastening mechanisms) to the deflector 16. The reclamation shroud 18 has a larger diameter than the deflector 16, where the combination of the reclamation shroud 18 and the deflector 16 somewhat resembles a saucer, although not limited to that geometry. The deflector 16 covers at least a portion of the fluid-discharge end of the cup 14. For instance, in one embodiment, the cup 14 comprises a circumferential, outward-directed lip 20 from which the substantially uniform size fluid droplets are dispensed in a circular flow pattern. The deflector 16 blocks all but a portion of the dispensed fluid, such as a portion that passes the deflector 16 through an aperture 22 to be applied to a target. As is described below, the aperture 22 is defined by a single arc (or a plurality of arcs in some embodiments) located on the surface of the deflector 16. The reclamation shroud 18 encircles the lip 20 and surrounds at least a portion of the cup 14, and is positioned relative to the coupled or integrated deflector 16 to collect the blocked fluid.

The CDA nozzle 12 also comprises a shaft 24 that runs longitudinally through at least a portion of the cup 14 and extends from each side of the cup 14. Disposed concentrically within the shaft is a hollow spindle 26 that introduces fluid into the cup 14. The shaft 24 is coupled to the cup 14 and is engaged by a drive system 28 to cause rotation of the cup 14 relative to the stationary spindle 26. The cup 14 rotates to produce droplets from an inputted fluid stream. In one embodiment, the drive system 28 comprises a rotational actuator 30 and pulley 32. The pulley 32 engages a wheel 34 of the rotational actuator 30 and also engages the shaft 24 of the nozzle 12 to cause rotation of the cup 14. The drive system 28 and nozzle 12 are mounted to a frame 36, the nozzle 12 mounted to the frame 36 by a mounting assembly 38 of the deflector 16. In some embodiments, the mounting assembly 38 and deflector 16 may comprise an integrated assembly (e.g., molded or cast), and in some embodiments, the mounting assembly 38 and deflector 16 may comprise separately coupled components. The frame 36 may be connected (e.g., in adjustable or fixed manner) to a boom of a self-propelled agricultural machine (e.g., sprayer) or to a towed implement. In one embodiment, the frame 36 rigidly secures the aforementioned components with respect to each other.

Fluid is provided to the input 40, the flow carried to the interior of the cup 14 via the spindle 26. The fluid may be provided through a flow control apparatus or system, as is known in the art. For instance, a flow control system may meter a defined volume of fluid into the spindle 26.

In one example operation, the rotational actuator 30 of the drive system 28 provides rotational motion to rotate the cup 14. In other words, the pulley 32 transfers the rotational motion of the rotational actuator 30 to the shaft 24, which through coupling between the shaft 24 and the cup 14, causes the cup 14 to rotate. The shaft 24 rotates around the hollow and stationary spindle 26. In one embodiment, an even flow of fluid is injected by a flow control system into the input 40. The fluid flows through the hollow spindle 26 and is discharged via openings in the spindle 26 into the interior space of the cup 14. In one embodiment, fins of a fin assembly located internal to the cup 14 divide and compartmentalize the fluid evenly inside the cup 14 and ensure that the cup 14 produces an even distribution of uniformly-sized droplets. In some embodiments, the fin assembly may be omitted.

It should be appreciated within the context of the present disclosure that variations of the aforementioned CDA system 10 are contemplated and considered to be within the scope of the disclosure. For instance, in some embodiments, the drive system 28 may include a belt, gears, chain, hydraulic motor, pneumatic motor, etc. In some embodiments, the depicted drive system 28 may be omitted in favor of drive system that includes a direct coupling between a motor and the cup 14. In some embodiments, additional structure and/or components may be included, such as a precise speed control of the cup 14, a fan to assist droplet travel and penetration (e.g., into foliage), among other structures. Although not limited to a specific performance, some example performance metrics of the CDA system 10 may include a minimum flow rate of approximately 0.05 gallons per minute (GPM), a maximum flow rate of approximately 0.3 GPM, a minimum cone speed of approximately 2500 RPM, and a maximum cone speed of approximately 5000 PRM. These metrics are merely illustrative, and some embodiments may have greater or lower values.

Attention is now directed to FIG. 1B, which provides a cutaway view of certain features of the CDA system 10 shown in FIG. 1A. Recapping from the description above, the CDA system 10 comprises the CDA nozzle 12. The CDA nozzle 12 comprises the cup 14, the deflector 16, the reclamation shroud 18 (the deflector 16 and reclamation shroud 18 shown in FIG. 1B as an integrated component), the shaft 24, and the spindle 26. In one embodiment, the cup 14 comprises a geometrical configuration that includes the circumferential lip 20 from which droplets are dispersed to a target according to a circular spray pattern. In one embodiment, the lip 20 is directed outward from the central axis of the cup 14. In some embodiments, the lip 20 is not directed outward relative to the central axis of the cup 14. The cup 14 also comprises a wide portion 42 and a narrow portion 44 that includes a base 46. The narrow portion 44 includes a diameter that decreases from the wide portion 42 to the base 46. In some embodiments, within the cup 14 corresponding to an interior surface of the narrow portion 44 is a fin assembly, as described further below. The interior surface of the cup 14 corresponding to the lip 20 and the wide portion 42 (and partially the narrow portion 44) comprises a plurality of longitudinal ridges 48, each pair of ridges 48 defining grooves therebetween to channel the fluid as the cup 14 rotates to provide a circular flow pattern of droplets released at the lip 20. In other words, the uniform droplets are dispersed from grooves (the grooves formed by plural ridges 48 in the interior surface of the cup 14, the ridges breaking off the droplets as the fluid flows from the grooves) at the lip 20 in circular fashion. All but a portion of the dispersed fluid is blocked by the deflector 16. The unblocked fluid dispersed from the lip 20 passes the deflector 16 via the aperture 22 and hence is directed to a target, such as the ground or foliage (e.g., crops, weeds, etc.). The blocked fluid is collected by the reclamation shroud 18 and routed by an internal channel 50 of the reclamation shroud 18, where the fluid ultimately is transferred to a reservoir.

The nozzle 12 further comprises the shaft 24, which extends from one side of the cup 14. The shaft 24 surrounds (e.g., concentrically) at least a portion of the hollow spindle 26. The hollow spindle 26 receives fluid (e.g., from a flow control system) at the input 40 and dispenses the fluid into the interior of the cup 14 corresponding to the narrow portion 44 (e.g., proximal to the base 46). Introduced in FIG. 1B is a circular cap 52 that segments the interior of the cup 14 in a plane proximal to the transition between the wide portion 42 and the narrow portion 44. In one embodiment, the cap 52 is integrated (e.g., molded, cast, etc.) with the shaft 24. In some embodiments, the cap 52 is coupled to the shaft 24 according to other known fastening mechanisms, such as via welding, riveting, screws, etc. In one embodiment, the cap 52 is also mounted to a fin assembly as described further below, although in some embodiments, the fin assembly may be omitted and the shaft 24 coupled to the cup 14 according to other fastening mechanisms. For purposes of brevity, the remainder of the disclosure contemplates the use of a fin assembly, with the understanding that the fin assembly may be omitted in some embodiments. The shaft 24 further comprises a hexagonal key portion 54 and bearing assembly 56 disposed between the frame 36 and the cup 14. The key portion 54 provides an area of engagement for the pulley 32 of the drive system 28, at the nozzle 12, the other area of engagement at the wheel 34 associated with the rotational actuator 30 of the drive system 28. The bearing assembly 56 (along with a bearing assembly on an opposing end of the spindle 26, as described below) enables the spindle 26 to guide the rotation of the shaft 24 and cone 14 relative to the stationary spindle 26, as driven by the drive system 28.

Also depicted in FIG. 1B, the deflector 16 and reclamation shroud 18 are coupled to the frame 36 via the mounting assembly 38. The mounting assembly 38 secures the shroud deflector 16 to the frame 36. The input end 40 extending beyond the frame 36 and a nut at the opposite end of the spindle 26 compress the frame 36, the pulley 32, shaft 24, and the cup 14 together. The deflector 26 and reclamation shroud 18 are mounted independently onto the frame 36, as noted above, and around the rotating sub-assembly (e.g., pulley 32, shaft 24, and cup 14), and hence the rotating sub-assembly rotates approximately in the middle of the deflector 16 and reclamation shroud 18. In some embodiments, the deflector 16 (and in some embodiments, the reclamation shroud 18) may be detachable from, yet coupled to, the portion (mounting assembly 38) that mounts to the frame 36. The deflector 16 may be adjusted to enable the cup 14 to disperse the fluid in a fully circular spray of fluid or positioned to enable a truncated spray pattern. For instance, the deflector 16 may be offset from the outlet (e.g., lip 20) of the cup 14 (e.g., lifted closer to the frame 36) to avoid interfering with the discharge of the fluid droplets and hence enable a fully circular spray pattern of uniform droplets from the lip 20. In some embodiments, the deflector 16 may be fixed in length between the frame 36 and the cup 14 (and hence removed to enable the fully circular spray). In some embodiments, the deflector 16 may be positioned to block all but a portion of the circular spray pattern of the dispersed fluid, enabling a truncated spray pattern (e.g., in the form of a single arc spray pattern or plural arc spray patterns). The positioning of the deflector 16 may be achieved through manual adjustment, or in some embodiments, automatically (e.g., as controlled by a stepper motor and/or driven gear assembly coupled to the frame 36).

Referring to FIG. 1C, an exploded view of certain features of the CDA system 10 of FIGS. 1A-1B is shown. The frame 36, wheel 34, pulley 32, and shaft 24 have already been described in association with FIGS. 1A-1B, and hence further discussion of the same is omitted here for brevity except where noted below. Of particular focus for purposes FIG. 1C is a fin assembly 58, which includes a ring 60, a plurality of fins 62 coupled to or integrated with the ring 60, and a plurality of pins 64 disposed between each pair of fins 62. The fin assembly 58 depicted in FIG. 1C is one example configuration, and it should be appreciated that other configurations of the fin assembly (e.g., with a fewer or greater number of pins 64 or fins 62) are contemplated to be within the scope of the disclosure. The fin assembly 58 is connected to the interior surface of the cup 14 corresponding to the narrow portion 44, and in particular, connected via the pins 64. Further, the cap 52 of the shaft 24 mounts to the fin assembly 58 via the pins 64 and the cap holes 66 of the cap 52. The cap 52 rests on an edge 68 of each fin 62 of the fin assembly 58. A bearing assembly 70 is located proximal to the base 46, as indicated above.

Turning attention now to FIG. 1D, shown in perspective is a portion of the interior of one embodiment of the cup 14 (with some features omitted for purposes of discussion, such as the cap 52). It should be appreciated within the context of the present disclosure that variations in the depicted structure are contemplated for certain embodiments, such as fewer or additional fins, and/or the extension (or reduction) of the quantity of ridges along a greater (or lesser) area of the interior surface of the cup 14. As depicted in FIG. 1D, the cup 14 comprises the hollow spindle 26 centrally disposed in the cup 14, as described above. The spindle 26 comprises one or more holes 72 that enable the discharge of the fluid into the interior of the cone proximal to the base 46. The cup 14 further comprises the longitudinal, discontiguous ridges 48 disposed on at least a portion of the interior surface (e.g., corresponding to the lip 20, wide portion 42, and a part (e.g., less than the entirety) of the narrow portion 44 (FIGS. 1A-1C). In some embodiments, the ridges 48 may occupy a larger amount of the interior surface, or a smaller part in some embodiments, or be contiguous throughout the interior surface of cup 14. Between the ridges 48 are grooves which enable the channeling of fluid injected from the spindle 26 to dispersion as droplets beyond the lip 20.

The interior of the cup 14 further comprises the fin assembly 58, as described above in association with FIG. 1C. In one embodiment, the fin assembly 58 is disposed in an interior space adjacent the narrow portion 44 (e.g., the narrow portion 44 having a decreasing diameter from the wide portion 42 to the base 46 (FIGS. 1A-1C). As described above, the fin assembly 58 comprises the ring 60 that, in one embodiment, encircles a central or center region of the cup 14 occupied by the spindle 26. In one embodiment, a central axis of the ring 60 is coincident with a central axis of the spindle 26. The ring 60 is integrated with (e.g., casted or molded, or in some embodiments, affixed to) the plurality of the fins 62. The fins 62 extend from a location longitudinally adjacent the spindle 26 to the interior surface of the cup 14. In one embodiment, one or more edges of each fin 62 is flush (e.g., entirely, or a portion thereof) with the interior surface of the cup 14. In some embodiments, one or more edges of each fin 62 is connected (e.g., along the entire edge or a portion thereof in some embodiments) to the interior surface of the cup 14. In some embodiments, a small gap is disposed between one or more edges of each fin 62 (or a predetermined number less than all of the fins 62) and the interior surface closest to the fin 62. In some embodiments, the fins 62 may be affixed to the ring 60 by known fastening mechanisms (e.g., welds, adhesion, etc.) or integrations (e.g., molded, cast, etc.). The ring 60 further comprises the plural pins 64 that enable the mounting of the cap 52 (FIG. 1C) of the shaft 24 (FIG. 1) to the fin assembly 58, which also enables the shaft 24 to cause the rotation of the cup 14. The pins 64 also secure the fin assembly 58 to the interior surface of the narrow portion 44.

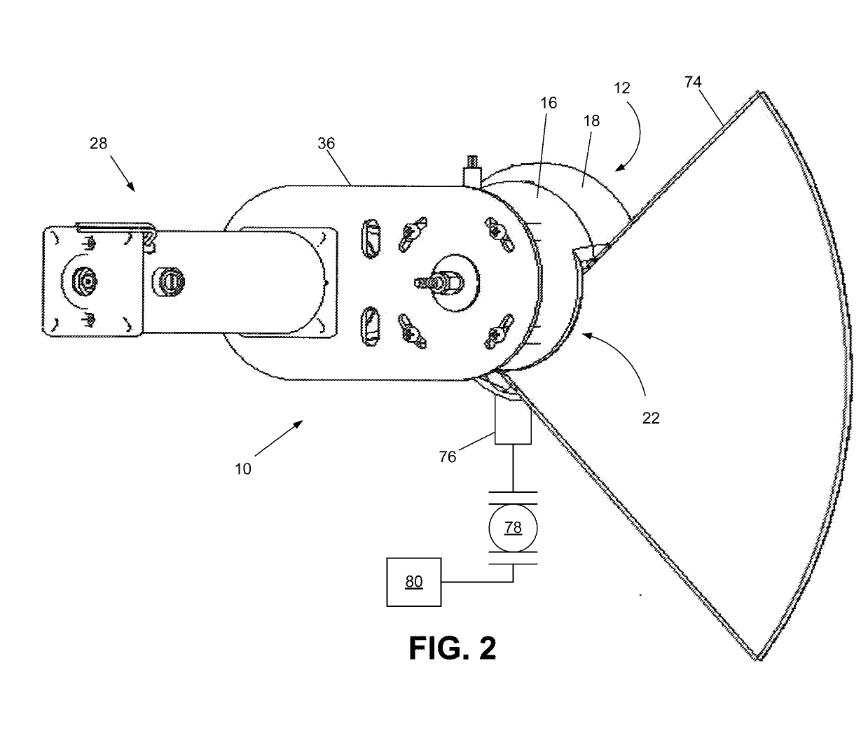

Referring now to FIG. 2, shown is a schematic diagram that illustrates, in a top plan view, an example, directional spray pattern provided by the example CDA system 10. It should be appreciated within the context of the present disclosure that the illustrated spray pattern is merely one example among numerous possible spray patterns that may be achieved depending on the configuration of the deflector 16 and/or the orientation of the axis of rotation of the cup 14. The frame 36 supports the nozzle 12, and as the cup 14 (FIGS. 1A-1D) rotates based on operation of the drive system 28, the circular spray pattern dispersed from the lip 20 (FIGS. 1A-1D) of the cup 14 is truncated by the deflector 16, resulting in the arc-shaped spray pattern 74 dispersed via the aperture 22 created in the deflector 16. The arc-shaped spray pattern 74 may be created from a single arc configuration on the surface of the deflector 16, or by plural adjacent or overlapping arc configurations on the surface of the deflector 16 in some embodiments. The portion of the fluid dispersed from the cup 14 and blocked by the deflector 16 is collected by the reclamation shroud 18 and redirected via a drain 76 and fluid transfer device 78 (e.g., pump, educator, control valve, etc.) to a reservoir 80. The reservoir 78 may re-introduce the reserved fluid back to the input 40 via suitable conduit and/or transfer mechanisms (e.g., tubing, pumps, etc.). In one embodiment, a reclamation system comprises the reclamation shroud 18, fluid transfer device 78, and reservoir 78. In some embodiments, the reclamation system may include additional (e.g., the deflector 16) or fewer features.

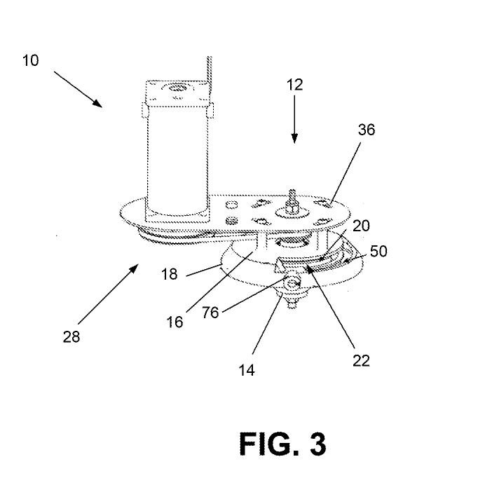

FIG. 3 provides another, partial view of the CDA 10 as depicted in FIG. 2, except with the cup 14 oriented to rotate vertically, some components omitted for brevity. The drive system 28 and nozzle 12 are coupled to the frame 36, as described above. The deflector 16 in this view is disposed above the reclamation shroud 18, with the aperture 22 providing an outlet for a truncated spray pattern (e.g., arc-shaped spray). The reclamation shroud 18 comprises the channel 50 disposed below the lip 20 (FIGS. 1A-1D) of the cup 14. The reclamation shroud 18 is adjacent at least in part the bottom edge of the deflector 16, and hence suitably positioned to collect the fluid in the channel 50 that is blocked by the deflector 16. The reclamation shroud 18 is coupled to (e.g., integrated or fastened) the deflector 16. The reclamation shroud 18 further comprises the drain 76 that, in one embodiment, is contiguous with the channel 50. The drain 76 enables the transfer of collected fluid from the channel 50 to the reservoir 80 in the manner described above in association with FIG. 2.

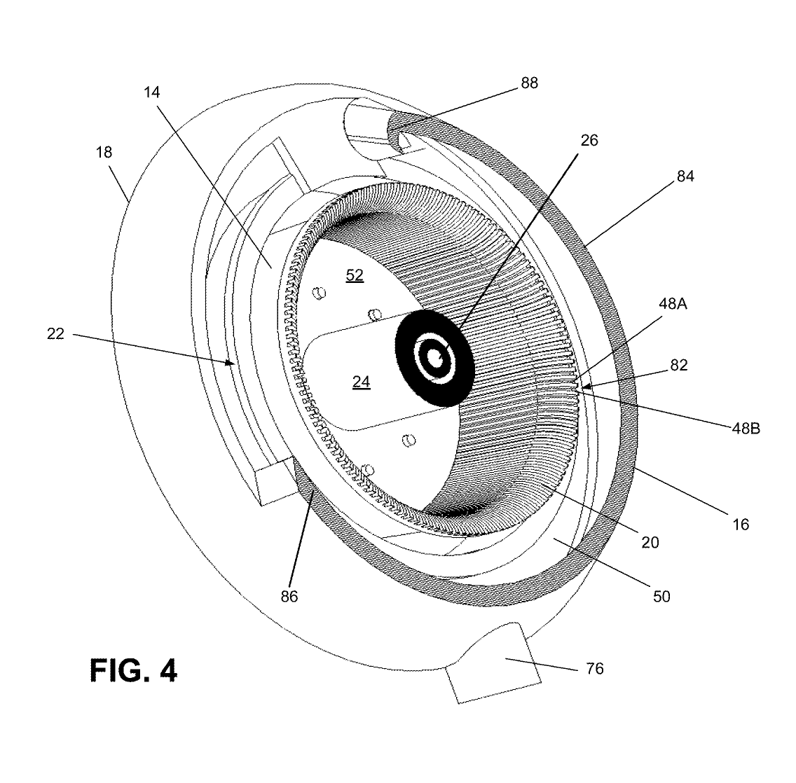

Referring to FIG. 4, shown is a schematic diagram from the perspective of the lip 20 and looking above the lip into the interior of the cup 14. Also shown is an embodiment of an example deflector 16 having a single arc on the surface used to block a single arc portion of a circular spray pattern dispersed from a circumferential lip 20 of the nozzle 12 (FIGS. 1A-1D). It should be appreciated within the context of the present disclosure that the configuration of the deflector 16 shown in FIG. 4 is one example among many possible configurations. For instance, in some embodiments, the deflector 16 may comprise plural arcs that are used to block plural discontiguous or contiguous portions of the fluid spray dispersed from the lip 20. The deflector 16 covers all but a portion (i.e., corresponding to the aperture 22) of the lip 20 of the cup 14. The shaft 24 is shown surrounding in concentric manner the spindle 26, where one end of the spindle 26 is obscured by the surface of the cap 52 that is disposed in the interior of the cup 14 and integrated with, or coupled to, the shaft 24. Grooves are shown more clearly in FIG. 4, such as groove 82 defined between adjacent ridges 48A and 48B. The grooves 82 channel the fluid within the interior of the cup 14 and are broken into uniform size droplets at the lip 20 by the ridges 48. Also shown in FIG. 4 is an arc 84 on the surface of the deflector 16, the arc 84 extending radially from approximately, using a clock analogy, the one o'clock position to the eight o'clock position when viewed in perspective. Other radial lengths of the arc 84 are contemplated to be within the scope of the disclosure. The arc 84 comprises a surface that radially covers the lip 20, except at the aperture 22. Functionally, the arc 84 enables the deflector 16 to block at least partially the circular spray dispersed at the lip 20, enabling a portion of the spray (e.g., a truncated portion of the circular spray) to pass through the aperture 22 and be applied to the target. The blocked portion is collected in the channel 50 and channeled through the drain 76 to the reservoir 80 (FIG. 2) as described above. Note that the reservoir 80 may be local to the CDA nozzle 12 or a tank of the agricultural machine, such as a sprayer tank.

The arc 84 comprises a leading edge 86 and a trailing edge 88, two edges which cut into the spray of the droplets. The leading edge 86 of the arc 84 of the deflector 16 comprises a sharp geometric configuration that cuts into the spray to reduce the transition area that may include an intermediate number of droplets. The trailing edge 88 of the deflector 16 has a hooked-configuration (e.g., the hook directed inward toward the center of the cup 14) to direct the fluid back around towards the bottom (e.g., when in vertical orientation) of the reclamation shroud 18, enabling the blocked fluid to be channeled along the channel 50 to the reservoir 80 (FIG. 2).

Note that some embodiments may omit the hooked configuration of the trailing edge 88, or have a different configuration (e.g., “L” shaped, etc.) to direct fluid back to the bottom of the reclamation shroud 18.

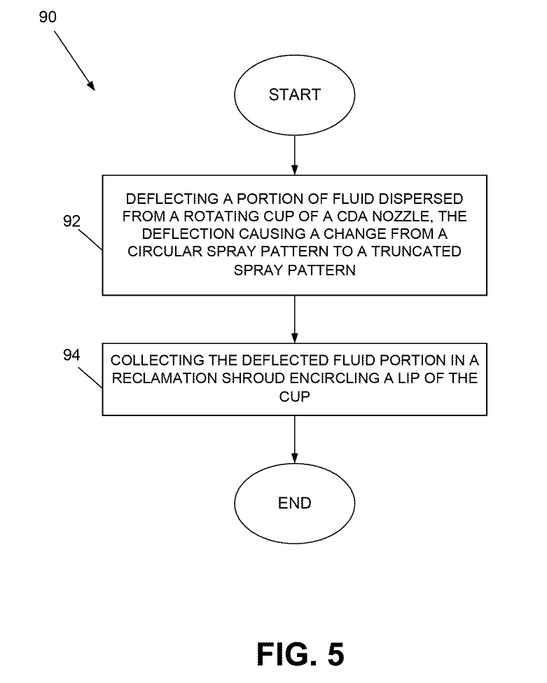

Having described certain embodiments of a CDA system 10, it should be appreciated within the context of the present disclosure that one embodiment of a CDA reclamation method (e.g., as implemented in one embodiment by the CDA system 10, though not limited to the specific structures shown in FIGS. 1A-4), denoted as method 90 and illustrated in FIG. 5, comprises deflecting a portion of fluid dispersed from a rotating cup of a CDA nozzle, the deflection causing a change from a circular spray pattern to a truncated spray pattern (92); and collecting the deflected fluid portion in a reclamation shroud encircling a lip of the cup (94).

Any process descriptions or blocks in flow diagrams should be understood as merely illustrative of steps performed in a process implemented by a CDA system, and alternate implementations are included within the scope of the embodiments in which functions may be executed out of order from that shown or discussed, including substantially concurrently or in reverse order, depending on the functionality involved, as would be understood by those reasonably skilled in the art of the present disclosure.

It should be emphasized that the above-described embodiments of the present disclosure are merely possible examples of implementations, merely set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and protected by the following claims.

At least the following is claimed:

1. A controlled droplet applicator (CDA) system, comprising:
a frame;
a CDA nozzle coupled to the frame, the CDA nozzle comprising:
a cup having plural ridges disposed on an interior surface of the cup, the cup comprising a lip on the open end of the cup;
a deflector coupled to the frame and covering all but a portion of the lip; and
a reclamation shroud coupled to the deflector and encircling the lip.

2. The CDA system of claim 1, wherein the reclamation shroud comprises a channel.

3. The CDA system of claim 2, wherein the reclamation shroud further comprises a drain port contiguous with the channel.

4. The CDA system of claim 3, wherein the CDA nozzle further comprises a fluid transfer device.

5. The CDA system of claim 4, further comprising a reservoir, wherein the fluid transfer device is coupled to the drain port and the reservoir.

6. The CDA system of claim 4, wherein the fluid transfer device comprises a pump.

7. The CDA system of claim 1, wherein the nozzle further comprises a shaft running at least partly through the cup and coupled to the cup.

8. The CDA system of claim 7, further comprising a drive system coupled to the shaft, the drive system configured to rotate the shaft and the cup relative to the reclamation shroud.

9. The CDA system of claim 1, wherein the reclamation shroud and the deflector are an integrated assembly.

10. A controlled droplet applicator (CDA) reclamation method, comprising:
deflecting a portion of fluid dispersed from a rotating cup of a CDA nozzle, the deflection causing a change from a circular spray pattern to a truncated spray pattern; and
collecting the deflected fluid portion in a reclamation shroud encircling a lip of the cup.

11. The method of claim 10, wherein deflecting comprises deflecting the fluid dispersed from the cup rotating along a horizontal axis.

12. The method of claim 10, further comprising channeling the collected fluid to a drain port of the reclamation shroud.

13. The method of claim 10, further comprising transferring the fluid from a drain port of the reclamation shroud to a reservoir.

14. The method of claim 10, wherein the truncated spray pattern comprises a single contiguous arc of fluid spray.

15. The method of claim 10, wherein the truncated spray pattern comprises plural discontiguous arcs of fluid spray.

16. The method of claim 10, further comprising passing the undeflected fluid spray to a target.
